(19) United States
(12) Patent Application Publication
(10) Pub. No.: US 2021/0312223 A1
(43) Pub. Date: Oct. 7, 2021

(54) AUTOMATED DETERMINATION OF TEXTUAL OVERLAP BETWEEN CLASSES FOR MACHINE LEARNING

(71) Applicant: SAP SE, Walldorf (DE)

(72) Inventors: Shachar Klaiman, Heidelberg (DE); Marius Lehne, Berlin (DE)

(73) Assignee: SAP SE, Walldorf (DE)

(21) Appl. No.: 16/840,947

(22) Filed: Apr. 6, 2020

(51) Int. Cl. G06K 9/62; G06K 9/00; G06F 40/30; G06F 40/284; G06F 40/166; G06N 20/10

(52) U.S. Cl. CPC G06K 9/628; G06K 9/6202; G06K 9/00456; G06N 20/10; G06F 40/284; G06F 40/166; G06F 40/30

(57) ABSTRACT

Technologies are described for the automated determination of semantic overlap between the texts of different classes for use in machine learning. Specifically, a group of classes can be analyzed to determine how much textual overlap and/or semantic overlap is present between the classes before the classes are used for machine learning modeling. If significant overlap is found between the classes, then the classes can be modified before they are used for machine learning modeling.

### BACKGROUND

Machine learning models are increasingly being used for data classification tasks. In order to generate such machine learning models, training data is used. The quality of the machine learning model thus depends on the quality of the training data that was used to train the model.

One problem that can arise when training a machine learning model is the quality of the training data. For example, if a model is generated using training data that has semantically overlapping classes, the quality of the model can be poor (e.g., the accuracy of the model when classifying input data may be low). Furthermore, detecting whether the training data contains semantically overlapping classes can be a difficult task. For example, it may not be until the model is created using the training data that the presence of semantically overlapping classes is detected. In addition, low model accuracy can be falsely attributed to reasons other than semantically overlapping classes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for the automated determination of semantic overlap between classes for use in machine learning. Specifically, a group of classes can be analyzed to determine how much textual overlap and/or semantic overlap is present between the classes before the classes are used for machine learning modeling. If significant overlap is found between the classes, then the classes can be modified before they are used for machine learning modeling.

For example, an automated process for determining semantic overlap between classes can comprise receiving a data set that comprises a plurality of documents, a plurality of classes, and indications of which classes have been assigned to which documents. A single vector representation can then be generated for each document. Using the single vector representations, a single aggregated vector can be generated for each class that represents the documents of the class. In some implementations, the single vector representations and the single aggregated vectors all have the same number of elements. An overlap value is then generated for each pair of classes based on the aggregated vectors for each pair of classes. The overlap value for a pair of classes represents the amount of textual overlap between the pair of classes. A representation of the overlap values can then be output.

### BRIEF DESCRIPTION OF THE DRAWINGS

FIG. 1 is a diagram depicting an example process for determining semantic overlap between classes.

FIG. 2 is a flowchart of an example process for determining semantic overlap between classes.

FIG. 3 is a flowchart of an example process for determining semantic overlap between classes, including identifying pairs of classes that have significant semantic overlap.

FIG. 4 is a diagram illustrating an example of automatically determining semantic overlap between classes.

FIG. 5 is a diagram illustrating an example of automatically determining semantic overlap between classes, including calculation of a pair-wise overlap matrix.

FIG. 6 is a diagram of an example computing system in which some described embodiments can be implemented.

FIG. 7 is an example cloud computing environment that can be used in conjunction with the technologies described herein.

### DETAILED DESCRIPTION

### Overview

The following description is directed to technologies for the automated determination of semantic overlap between classes (i.e., between the text of documents assigned to different classes) for use in machine learning. Specifically, a group of classes is analyzed to determine how much semantic overlap is present between the text of documents assigned to the classes before the classes are used for machine learning modeling. If significant overlap is found between the classes, then the classes can be modified before they are used for machine learning modeling.

For example, an automated process for determining semantic overlap between classes can comprise receiving a data set that comprises a plurality of documents, a plurality of classes, and indications of which classes have been assigned to which documents. A single vector representation can then be generated for each document. Using the single vector representations, a single aggregated vector can be generated for each class that represents the documents of the class. In some implementations, the single vector representations and the single aggregated vectors all have the same number of elements (e.g., corresponding to the size of the vocabulary). An overlap value is then generated for each pair of classes based on the aggregated vectors for each pair of classes. The overlap value for a pair of classes represents the amount of textual overlap between the pair of classes. A representation of the overlap values can then be output (e.g., displayed to a user in a matrix, list, or other format).

For example, the automated semantic overlap technologies described herein can fully automate the analysis of classes (e.g., received as part of a set of training data) before they are used for creating a machine learning model. For example, the technologies can automatically identify pairs of classes that have significant (e.g., above an overlap threshold) semantic overlap. From the identified classes, corrective action can be taken. For example, classes that have significant semantic overlap can be modified (e.g., classes can be combined, classes can be changed, classes can be deleted or added, etc.).

In the technologies described herein, the amount of semantic overlap between classes is determined before machine learning modeling is performed using the classes (e.g., before a machine learning model is generated using the classes). In other words, the technologies described herein are not analyzing machine learning model results. Instead, the semantic overlap analysis is performed directly from the data (e.g., from training data including the classes, documents, and associations) as a pre-modeling analysis phase.

In typical solutions, machine learning models are created from training data without examining the classes being used. However, when the classes are not analyzed to determine how they might affect machine learning modeling, problems can arise. For example, if classes with significant textual overlap are used for creating a machine learning model, the model may not be able to accurately assign classes to input text (e.g., the model may not be able to distinguish between different text inputs that have textual overlap). In other words, two different input texts that have the same semantic meaning may be assigned to two different classes. This problem can result in low quality machine learning models.

The technologies described herein provide advantages over typical solutions. For example, the automated semantic overlap technologies can automatically identify the presence of semantically overlapping classes. For example, the technologies can automatically identify pairs of classes that have significant semantic overlap (e.g., above an overlap threshold). From the identified classes, corrective action can be taken. For example, classes that have significant semantic overlap can be modified (e.g., classes can be combined, classes can be changed, classes can be deleted or added, etc.). By identifying semantically overlapping classes, machine learning modeling can be performed more efficiently and accurately. For example, by identifying and modifying semantically overlapping classes (e.g., in training data), and using the modified classes in machine learning modeling, higher quality models can be produced (e.g., with improved accuracy). In addition, time and computing resources that would otherwise be spent creating, and re-creating, models with problematic classes can be reduced or eliminated (e.g., by identifying and correcting classes before they are used to create machine learning models).

### Documents

As used herein, a document refers to a computer document that contains, at least in part, text content. Examples of documents include emails, word processing documents, text messages, computer-generated transcriptions from calls, and/or any other type of document that can be processed by a computing device that contains text content. Documents can also contain non-text content such as images. Documents can contain text in a variety of languages (e.g., one or more languages).

As an example, documents can be generated within a service ticket environment where customers generate service tickets. The service tickets could be information technology (IT) service tickets, customer help service tickets, or service tickets within another domain. An example customer help service ticket could be at text document (e.g., email or instant message) with text content such as “When will my order ship?” or “Please change my billing address to (new address)” or “I need to change my order (change details).”

In some implementations, the text of a document is filtered before it is used in a process for determining semantic overlap. Filtering can comprise removing stop words which may not be useful for determining the semantic overlap between documents (e.g., in English, words such as “a,” “an,” “the,” etc.). In some implementations, words are filtered based on their length. For example, words having less than a threshold number of characters can be filtered out and not used in the semantic overlap analysis. Filtering based on a threshold number of characters can be performed regardless of which language (or languages) the document is written in. Filtering based on a threshold number of characters can be more efficient than maintaining a specific list of stop words (e.g., which may need to be maintained for each of a plurality of languages). In addition, filtering based on a threshold number of characters can allow the semantic overlap analysis to be performed on longer words, which are typically more relevant to the meaning of the text.

In some implementations, filtering the text of a document comprises replacing certain terms with tokens. The certain terms that are replaced are those whose specific content is typically not important to the semantic overlap analysis. For example, the certain terms can include numbers, email addresses, dates, URLs, etc. For example, the certain terms can be replaced with tokens, such as replacing all instances of email addresses with “{email}” or replacing all instances of numbers with “{number}”. The tokens can be used with the semantic analysis (e.g., added to the vocabulary), so that the semantic overlap analysis can take into account occurrences of the certain terms (e.g., emails, dates, etc.) in the documents, without having to maintain the content of the certain terms (e.g., each unique email address, etc.). For example, it may be useful to know that a document contains an email address or a number, without having to maintain the specific content of the email addresses or numbers.

### Classes

Using the technologies described herein, documents can be assigned classes based on the text content they contain. Classes (also referred to as labels) are used to assign meanings to documents. For example, a classification system can receive a set of classes and a set of documents, and assign classes to the documents based on the text content of the documents. The result of the classification system would be the set of documents, the set of classes, and the associations between them. The specific classes that are included in the set of classes depends on the type of documents being analyzed (e.g., the domain). For example, a specific set of classes can be created that deal with customer questions for an online ordering system (e.g., customer questions about orders, addresses, payment information, etc.).

Using the example service ticket documents above, the following table (Table 1) depicts example classes that could be assigned to example documents.

TABLE 1

| Class | Document |
|---|---|
| Order status | When will my order ship? |
| Address change | Please change my billing address to (new address). |
| Order change | I need to change my order (change details). |

Depending on the specific classes, the documents, and/or other factors, there can be some ambiguity when assigning a class to a document. For example, the situation can arise where two classes are appropriate (e.g., equally or nearly equally appropriate) for a given document. This problem is referred to herein as semantic overlap. For example, consider a document (e.g., an email) in the travel domain related to a work conference. The document might be assigned to an education class or a work travel class. If either class could be assigned to the document (e.g., if there is a chance that a machine learning model could apply either class), then there is a semantic overlap between the classes.

In general, semantically overlapping classes occur when two or more classes could be assigned for a given document (e.g., the document is ultimately assigned one of the classes, but there is a probability that any one of the two or more classes could be assigned). Semantic overlap can be a problem for automated systems. For example, if two documents that have the same (or nearly the same) meaning are assigned to different classes, then the accuracy of the model will be reduced.

### Determining Semantic Overlap Between Classes

Using the technologies described herein, the amount of semantic overlap between classes can be determined. For example, a data set can be received (e.g., comprising historical data indicating associations between a set of classes and a set of documents). The data set can be analyzed to determine the amount of semantic overlap between the classes. The amount of semantic overlap can indicate the quality of the classes (e.g., how accurately the classes can be used to uniquely group the documents).

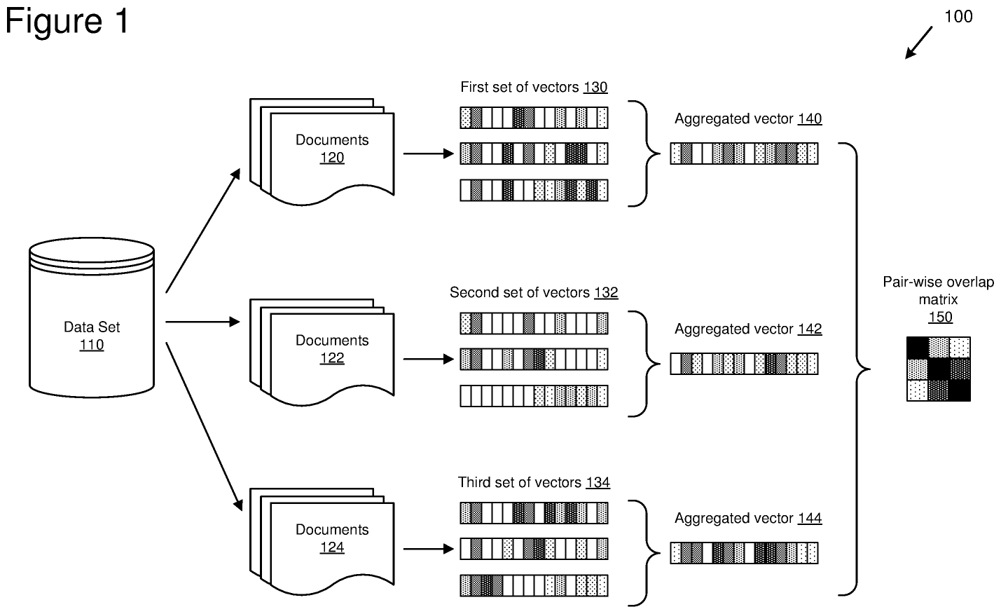

FIG. 1 is a diagram depicting an example process 100 for determining semantic overlap between classes. As depicted in the example process 100, there is a data set 110. The data set 110 comprises a plurality of documents (comprising text content) and a plurality of classes. The data set 110 also comprises indications of which of the plurality of classes have been assigned to which of the plurality of documents. For example, each document of the plurality of documents can be associated with a specific class of the plurality of classes. In some implementations, the data set 110 is a historical data set (e.g., generated by a manual process or an semi-automated process) to be used as training data. For example, the data set 110 can be a historical data set that was generated from a manual process in which a user (or users) classified the documents in the data set. As a result of the manual (or semi-automated) classification by users, the data set may contain semantic problems. For example, the users may have classified documents having the same or similar text into different classes, resulting in semantic overlap between the classes.

As depicted in the example process 100, the data set 110 includes a number of documents. Specifically, there are three groups of documents depicted: a first group of documents 120 (containing three documents), a second group of documents 122 (containing three documents), and a third group of documents 124 (containing three documents). Documents 120 are those documents that are associated with a first class (that were assigned to the first class in the data set 110). Documents 122 are those documents from the data set 110 that are associated with a second class. Documents 124 are those documents from the data set 110 that are associated with a third class. While only three example groups of documents (nine documents total), and three associated classes, are depicted for illustration purposes, the technologies described herein can be applied to data sets containing any number of documents that are associated with any number of classes.

Once the documents, the classes, and the associations between them have been obtained, a representation is generated for each document. In some implementations, the representation is a single vector for each document. Each of the single vectors has the same number of elements. In some implementations, each element of a vector represents a word in a vocabulary (where the vocabulary represents the words in the documents of the data set). For example, a vocabulary can be generated from the documents in the data set 110 (e.g., after being filtered). In some implementations, the elements represent something other than a vocabulary (e.g., when using a neural network).

As depicted in the example process 100, there is a first group of vectors 130. The first set of vectors 130 contains three vectors, each representing one of the three documents 120. Each of the vectors in the set of vectors 130 has the same length. The elements of the vectors are shaded differently to reflect the value or importance of each element, which can be calculated in a variety of ways as discussed further below. Also depicted in the example process 110 is a second set of vectors 132 representing the second group of documents 122, and a third set of vectors 134 representing the third group of documents 124. All of the sets of vectors (the first, second, and third sets of vectors 130, 132, and 134) all have the same number of elements. However, the values of the elements for each vector are uniquely calculated for that vector.

In some implementations, a term-frequency inverse-document-frequency (tf-idf) representation is used for the single vector representation for each document. A tf-idf representation is calculated for each document in order to obtain the term importance for each document. The following equation (Equation 1) is used to calculate the tf-idf representation.

tf-idf(t,d)=tf(t,d)×idf(t) (Equation 1)

In Equation 1, “t” represents a word in a document, and “d” represents a document. The tf-idf value (also referred to as importance) of a word in a document increases with the number of times the word appears in the document and decreases by the number of documents in the data set that the word appears in.

As part of generating the representation (e.g., single vector) for each document, the text content of the document can be filtered. Filtering can comprise removing stop words, removing words that have less than a threshold number of characters (e.g., less than 4 characters), and/or replacing specific terms with tokens. In some implementations, filtering is performed as part of determining a tf-idf representation for the documents (e.g., before generating a vocabulary that will be used for the tf-idf calculation).

Other techniques can be used (e.g., instead of tf-idf) to generate the single vector representation for each document. For example, natural language processing techniques can be used, such as a bag-of-words model or a trained neural network.

After the single vectors have been generated, an aggregation operation is performed for each set of vectors. The aggregation operation is performed to generate a single aggregated representation for each class (e.g., a single vector from the set of vectors of each class). For example, the first set of vectors 130 is aggregated to generate the single aggregated vector 140, the second set of vectors 132 is aggregated to generate the single aggregated vector 142, and the third set of vectors 134 is aggregated to generate the single aggregated vector 144. The single aggregated vector represents all of the documents of its associated class. For example, the single aggregated vector 140 represents all of the first group of documents 120 (that are associated with the first class).

The single aggregated representation has the same number of elements as the single vectors representing the documents (e.g., aggregated vector 140 has the same number of elements as each vector of the first set of vectors 130). In general, the aggregated representation generates a single D-dimensional aggregated vector for a given class from N D-dimensional vectors of the given class. In some implementations, the number of elements is equal to the elements in the vocabulary.

In some implementations, the aggregation operation is an averaging operation that calculates the single aggregated vector by averaging the elements of the set of single vectors. In other implementations, a different aggregation function is used (e.g., weighted average, median function, maximum function, trained neural network that performs averaging, etc.).

In some implementations, an aggregated vector rₗ is calculated for each class by using some function f(Dₗ), where Dₗ is a matrix containing the set of single vectors for the given label l. For example, the function can be an element-wise average.

After the aggregated vectors have been generated, overlap values are generated for pairs of classes (e.g., for each pair of classes). An overlap value for a given pair of classes indicates how much the aggregated vectors of each class of the pair overlap (e.g., how much each element of the aggregated vectors of the two classes overlap). For example, if there are three classes, then a first overlap value can be generated for the first class, second class pair. A second overlap value can be generated for the first class, third class pair. And, a third overlap value can be generated for the second class, third class pair. The overlap value for a given pair of values indicates how much of a textual overlap there is between the given pair of values. In some implementations, the overlap values are generated by calculating the scalar product for each pair of classes. For example, to calculate the overlap value for the first class and the second class, the scalar product is calculated for the aggregate vector of the first class and the aggregate vector of the second class. The overlap values can be provided as a list of values or in another format (e.g., a matrix).

In some implementations, the overlap values are normalized (e.g., with a minimum of 0.0 and a maximum of 1.0). For example, a normalization function can be used when calculating the overlap values (e.g., the values of the aggregated vector elements can be normalized before the overlap values are calculated).

In some implementations, the overlap values are generated as a pair-wise overlap matrix. For example, if there are three classes, then the pair-wise overlap matrix would be a three-by-three matrix. Such a pair-wise overlap matrix is depicted at 150, and is generated from the aggregated vectors 140, 142, and 144. The values along the diagonal (from top-left to bottom-right) are all 1.0 (e.g., normalized) because they represent the same class pair (e.g., the top-left value is the first class—first class pair).

Once the overlap values have been generated, they can be output. For example, the specific values can be output (e.g., displayed, emailed, stored, etc.). For example, a pair-wise overlap matrix can be displayed to a user so that the user can visually identify which classes have a high degree of textual overlap.

In some implementations, classes that have substantial textual overlap are identified so that additional action can be taken. Classes that have substantial textual overlap indicate a high likelihood of semantic overlap between the classes. In order to address this problem before the classes are used for machine learning modeling, action can be taken to modify the classes to reduce the amount of textual overlap between them. For example, if two classes are identified as having a substantial textual overlap (e.g., an overlap value over a threshold amount), then the two classes can be modified. In some implementations, modification of two identified classes includes merging the two identified classes into a single class. Merging the two identified classes can result in more accurate classification and improve the effectiveness of machine learning models that use the classes.

### Methods for Automated Determination of Semantic Overlap

In the technologies described herein, methods can be provided for automated determination of semantic overlap between classes. For example, hardware and/or software elements can perform operations to automatically calculate overlap scores between pairs of classes that indicate how much semantic overlap is present between the pairs of classes.

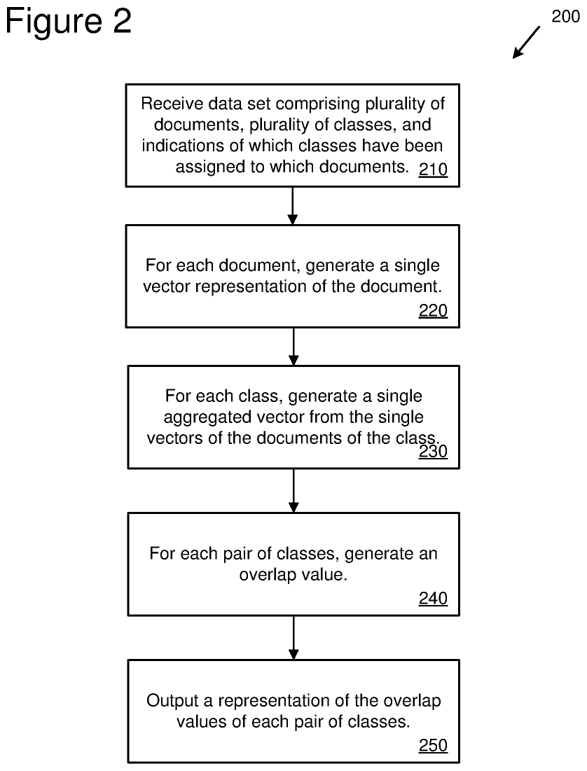

FIG. 2 is a flowchart depicting an example process 200 for automated determination of semantic overlap between classes. At 210, a data set is received. The data set comprises a plurality of documents, a plurality of classes, and indications of which classes have been assigned to which documents. The plurality of documents comprise text content.

For example, each of the documents can be associated with a class. The data set can be received as a set of training data intended to be used to train a machine learning model. Before the data set is used to train the machine learning model, it can be analyzed using the example process 200 to determine the amount of semantic overlap between the classes in the data set. Depending on results of the analysis, the classes of the data set can be modified (e.g., classes can be combined, classes can be redefined, classes can be deleted, etc.).

At 220, a single vector representation is generated for each document. In some implementations, the single vector representation is generated using a tf-idf representation. In some implementations, each single vector representation has the same number of elements (e.g., equal to a vocabulary generated from the plurality of documents).

At 230, for each class, a single aggregated vector is generated from the single vectors that represent the documents of the class. In some implementations, the single aggregated vector of each class has the same number of elements as the single vector representations of the documents of the class. For example, the single aggregated vector can be calculated using the element-wise average of the single vector representations of the documents of the class.

At 240, an overlap value is generated for each pair of classes (e.g., for each unique combination of two classes from the plurality of classes). The overlap value represents textual overlap between the pair of classes indicating how much semantic overlap is present between the pair of classes. The overlap value for the pair of classes is generated based on the single aggregated vectors for the pair of classes. For example, the overlap values for each pair of classes can be generated by calculating a scalar product from the single aggregated vectors of the pair of classes.

At 250, a representation of the overlap values is output for each pair of classes. For example, the representation of the overlap values can be a list of overlap values (e.g., one overlap value per each unique pair of classes), a pair-wise overlap matrix, or some other representation.

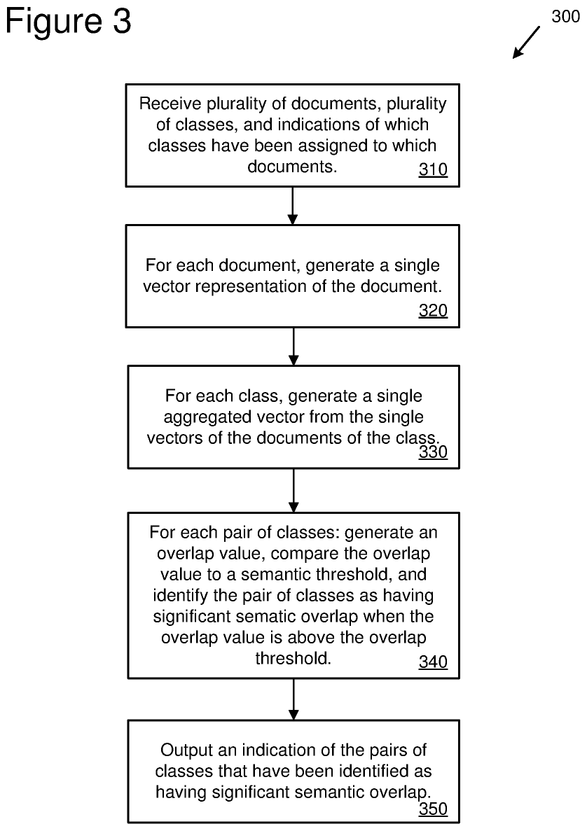

FIG. 3 is a is a flowchart of an example method 300 for automated determination of semantic overlap between classes, including identifying pairs of classes that have significant semantic overlap. At 310, a plurality of documents, a plurality of classes, and indications of which classes have been assigned to which documents is received. For example, the documents, classes, and associations can be received as a data set. The plurality of documents comprise text content.

For example, each of the documents can be associated with a class. The documents, classes, and associations can be received as a set of training data intended to be used to train a machine learning model. Before the training data is used to train the machine learning model, it can be analyzed using the example process 300 to determine the amount of semantic overlap between the classes. Depending on results of the analysis, the classes can be modified (e.g., classes can be combined, classes can be redefined, classes can be deleted, etc.).

At 320, a single vector representation is generated for each document. In some implementations, the single vector representation is generated using a tf-idf representation. In some implementations, each single vector representation has the same number of elements (e.g., equal to a vocabulary generated from the plurality of documents).

At 330, for each class, a single aggregated vector is generated from the single vectors that represent the documents of the class. In some implementations, the single aggregated vector of each class has the same number of elements as the single vector representations of the documents of the class. For example, the single aggregated vector can be calculated using the element-wise average of the single vector representations of the documents of the class.

At 340, a number of operations are performed for each pair of classes (e.g., for each unique combination of two classes from the plurality of classes). First an overlap value is generated for the pair of classes. The overlap value represents textual overlap between the pair of classes indicating how much semantic overlap is present between the pair of classes. The overlap value for the pair of classes is generated based on the single aggregated vectors for the pair of classes. For example, the overlap value for the pair of classes can be generated by calculating a scalar product from the single aggregated vectors of the pair of classes. Second, the overlap value can be compared to a semantic threshold (e.g., a predetermined threshold value). Third, the pair of classes is identified as having significant semantic overlap when the overlap value is above the overlap threshold.

At 350, an indication of the pairs of classes that have been identified as having significant semantic overlap is output. For example, the identified pairs of classes can be displayed (e.g., the list of identified classes with or without their respective overlap values), emailed, saved to a log file, or output in another manner

### Example Semantic Overlap Analysis

This section illustrates an example of automatically determining semantic overlap. In this example, the input data (e.g., the data set) has four documents (e.g., four email messages or text messages) and two classes. As depicted in Table 2 below, two documents (documents one and two) are associated with the first class (address change) and the other two documents (documents three and four) are associated with the second class (order change).

TABLE 2

| Class | Document |
|---|---|
| Address | “Dear Sir or Madam |
| change | Please update my address to 1234 Noti street. |
| | Best, |
| | Anakin” |
| Address | “Dear Sir, |
| change | I would like to update my address to 1234 Noti street. |
| | Best, |
| | Anakin” |
| Order | “Dear Sir or Madam |
| change | I would like to cancel my order #1234. |
| | Best, |
| | Anakin” |
| Order | “Dear Sir or Madam |
| change | I would like to update my order #1234. |
| | Best, |
| | Anakin” |

Before generating the single vector representations for each document, the documents are filtered. In this example, the documents are filtered to remove the stop words “I,” “to,” “or,” and “my.” For example, the stop words can be determined from a list of stop words. The documents can also be filtered by filtering out words that are less than a threshold length (e.g., less than three characters long).

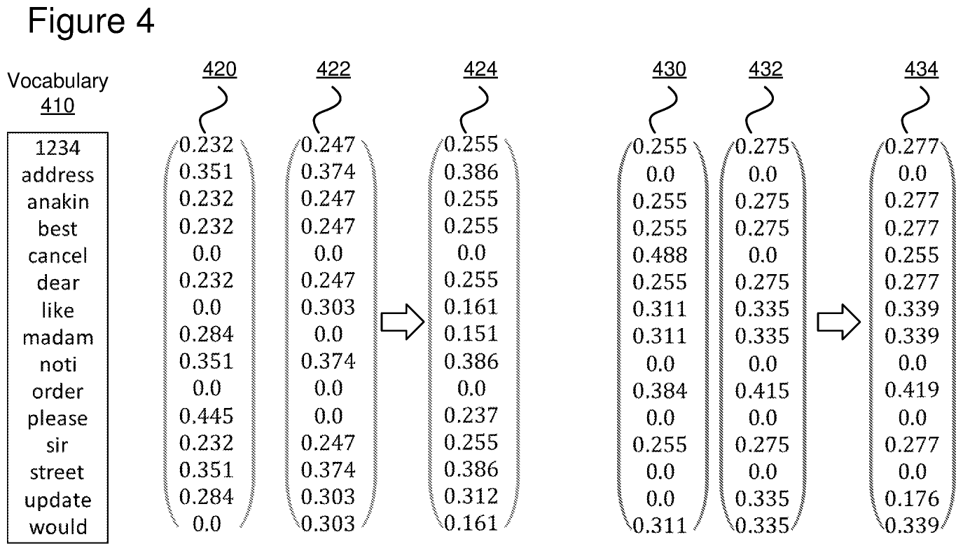

In this example, after filtering is performed, a vocabulary is created from the remaining words of the documents. The vocabulary contains each unique remaining word in the documents. In this example, FIG. 4 depicts the words in the vocabulary 410.

Next, a single vector representation is generated for each document. In this example, the single vector representations are generated as tf-idf representations. The tf-idf representations are depicted in FIG. 4. Specifically, a set of single vector representations is generated for the documents in each class. For the first class, “address change,” the single vector tf-idf representation of the first document is depicted at 420 and the single vector tf-idf representation of the second document is depicted at 422. For the second class, “order change,” the single vector tf-idf representation of the third document is depicted at 430, and the single vector tf-idf representation of the fourth document is depicted at 432. As depicted in FIG. 4, the single vector tf-idf representations all have the same number of elements, which is the same as the number of words in the vocabulary 410, and each element in the single vector tf-idf representations corresponds to one of the words in the vocabulary 410. For example, the second element in the single vector tf-idf representation of the first document depicted at 420 is the calculated tf-idf value of “0.351” for the word “address” with regard to the first document.

After the single vectors have been generated for the documents of each class, an aggregation operation is performed for each set of vectors. In this example, the single vector tf-idf representations for the documents of each class are averaged to create the single aggregated vectors for each class. Specifically, the single vector tf-idf representations 420 and 422 are averaged to generate the single aggregated vector 424 for the first class. The single vector tf-idf representations 430 and 432 are averaged to generate the single aggregated vector 434 for the second class. In this example, the single aggregated vectors 424 and 434 have the same number of elements as the single vector tf-idf representations.

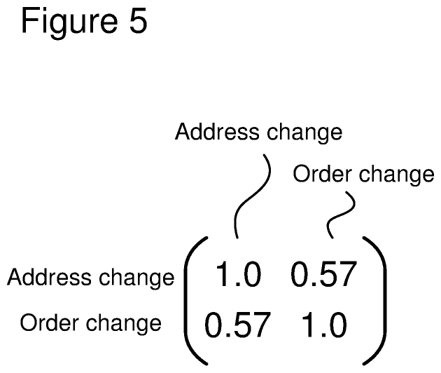

After the aggregated vectors 424 and 434 have been generated, overlap values are generated for pairs of classes. In this example, the overlap values are generated in the form of a pair-wise overlap matrix as the scalar product of the aggregated vectors 424 and 434, which is depicted in FIG. 5. Because there are only two classes in this example, the pair-wise overlap matrix in FIG. 5 is a two-by-two matrix. The pair-wise overlap matrix includes an overlap value calculated for each pair of classes. Specifically, there is an overlap value for the address change—address change pair, the order change—address change pair, the order change—address change pair, and the order change—order change pair. The diagonal values (address change—address change, and order change—order change) can be ignored because they represent a class compared with itself (e.g., they have normalized values of 1.0). In this example, because there are only two classes, the only relevant overlap value is 0.57, which represents the textual overlap between the order change class and the address change class.

The overlap value of 0.57 represents the amount of textual overlap between the order change class and the address change class, which in turn indicates the amount of semantic overlap between the text of the documents that have been assigned to the order change class and the text of the documents that have been assigned to the address change class. The overlap value of 0.57 can be represented as a numerical value (as in this example) or in another format (e.g., as a graph or as a relative shaded representation as used in the example pair-wise overlap matrix 150).

In some implementations, the overlap value is compared to an overlap threshold. An overlap value greater than the overlap threshold can indicate significant semantic overlap between the classes. The specific value of the overlap threshold can be determined empirically (e.g., from the semantic overlap values, such as determining the overlap threshold so that it separates relatively high overlap values from relatively low overlap values).

### Computing Systems

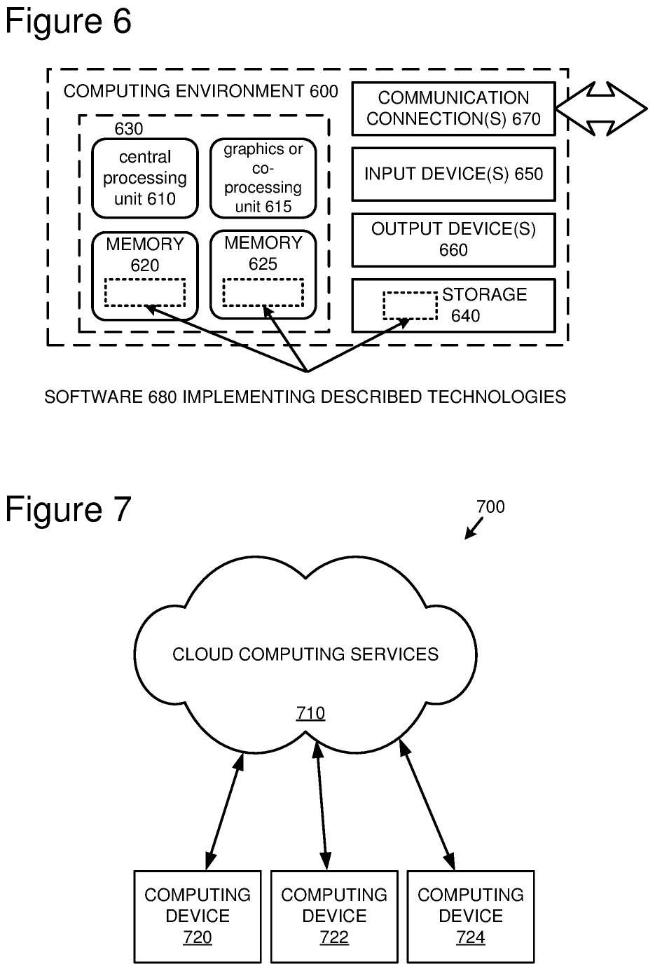

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud Computing Environment

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, database resources, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operators (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 6, computer-readable storage media include memory 620 and 625, and storage 640. The term computer-readable storage media does not include signals and carrier waves. In addition, the term computer-readable storage media does not include communication connections, such as 670.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed by one or more computing devices, for automated determination of semantic overlap between classes, the method comprising:
receiving a data set comprising a plurality of documents and a plurality of classes, wherein the plurality of documents comprise text content, and wherein the data set comprises indications of which of the plurality of classes have been assigned to which of the plurality of documents;
for each document of the plurality of documents, generating a single vector representation for the document, wherein each single vector representation has a same number of elements;
for each class of the plurality of classes:
generating a single aggregated vector from the single vectors that represent the documents of the class, wherein the single aggregated vector has the same number of elements;
for each pair of classes of the plurality of classes:
generating an overlap value for the pair of classes, wherein the overlap value represents textual overlap between the pair of classes indicating how much semantic overlap is present between the pair of classes, and wherein the overlap value for the pair of classes is generated based on the single aggregated vectors for the pair of classes; and
outputting a representation of the overlap values for each pair of classes;
wherein the method is performed as a pre-processing operation before the plurality of classes are used for machine learning modeling.

2. The method of claim 1, wherein generating the single vector representation for each document comprises:
calculating a term-frequency inverse-document-frequency (tf-idf) representation for each document.

3. The method of claim 1, wherein the same number of elements represents a number of words in the plurality of documents.

4. The method of claim 1, wherein the overlap values for each pair of classes are generated by calculating a scalar product from the single aggregated vectors of the pair of classes.

5. The method of claim 1, wherein the overlap values for each pair of classes are generated by calculating a pair-wise overlap matrix from the single aggregated vectors of the plurality of classes.

6. The method of claim 1, further comprising:
for each document:
before generating the single vector representation for the document, filtering the document to remove stop words.

7. The method of claim 6, wherein filtering the document to remove stop words comprises filtering words that are less than a threshold length.

8. The method of claim 1, further comprising:
for each document:
before generating the single vector representation for the document, filtering the document to replace certain terms with tokens, wherein the certain terms comprise email addresses, dates, numbers, and URLs.

9. The method of claim 1, further comprising for each pair of classes of the plurality of classes:
comparing the overlap value to a semantic threshold; and
when the overlap value is above the semantic threshold, identifying the pair of classes as having significant semantic overlap.

10. The method of claim 1, further comprising:
based at least in part on the overlap values, modifying the plurality of classes to reduce the semantic overlap between them.

11. The method of claim 10, wherein modifying the plurality of classes comprises combining at least two of the plurality of classes into a single class.

12. The method of claim 10, further comprising:
using the modified plurality of classes to perform machine learning modeling.

13. One or more computing devices comprising:
processors; and
memory;
the one or more computing devices configured, via computer-executable instructions, to perform operations for automated determination of semantic overlap between classes, the operations comprising:
receiving a data set comprising a plurality of documents and a plurality of classes, wherein the plurality of documents comprise text content, and wherein the data set comprises indications of which of the plurality of classes have been assigned to which of the plurality of documents;
for each document of the plurality of documents, generating a single vector representation for the document, wherein each single vector representation has a same number of elements;
for each class of the plurality of classes:
generating a single aggregated vector from the single vectors that represent the documents of the class, wherein the single aggregated vector has the same number of elements;
for each pair of classes of the plurality of classes:
generating an overlap value for the pair of classes, wherein the overlap value represents textual overlap between the pair of classes indicating how much semantic overlap is present between the pair of classes, and wherein the overlap value for the pair of classes is generated based on the single aggregated vectors for the pair of classes; and
outputting a representation of the overlap values for each pair of classes;
wherein the operations are performed as pre-processing before the plurality of classes are used for machine learning modeling.

14. The one or more computing devices of claim 13, wherein generating the single vector representation for each document comprises:
calculating a term-frequency inverse-document-frequency (tf-idf) representation for each document.

15. The one or more computing devices of claim 13, wherein the overlap values for each pair of classes are generated by calculating a scalar product from the single aggregated vectors of the pair of classes.

16. The one or more computing devices of claim 13, further comprising:
for each document:
before generating the single vector representation for the document, filtering the document to remove words that are less than a threshold length.

17. The one or more computing devices of claim 13, the operations further comprising:
for each document:
before generating the single vector representation for the document, filtering the document to replace certain terms with tokens, wherein the certain terms comprise email addresses, dates, numbers, and URLs.

18. The one or more computing devices of claim 13, the operations further comprising for each pair of classes of the plurality of classes:
comparing the overlap value to a semantic threshold;
when the overlap value is above the semantic threshold, identifying the pair of classes as having significant semantic overlap.

19. One or more computer-readable storage media storing computer-executable instructions for execution on one or more computing devices to perform operations for automated determination of semantic overlap between classes, the operations comprising:
receiving a plurality of documents, a plurality of classes, and associations between the plurality of documents and the plurality of classes, wherein the plurality of documents comprise text content;
for each document of the plurality of documents, generating a single vector representation for the document, wherein each single vector representation has a same number of elements;
for each class of the plurality of classes:
generating a single aggregated vector from the single vectors that represent the documents of the class, wherein the single aggregated vector has the same number of elements;
for each pair of classes of the plurality of classes:
generating an overlap value for the pair of classes, wherein the overlap value represents textual overlap between the pair of classes indicating how much semantic overlap is present between the pair of classes, and wherein the overlap value for the pair of classes is generated based on the single aggregated vectors for the pair of classes;
comparing the overlap value to a semantic threshold; and
when the overlap value is above the semantic threshold, identifying the pair of classes as having significant semantic overlap; and
outputting an indication of the pairs of classes that have been identified as having significant semantic overlap;
wherein the operations are performed as pre-processing before the plurality of classes are used for machine learning modeling.

20. The one or more computer-readable storage media of claim 19, the operations further comprising:
based at least in part on the overlap values, modifying the plurality of classes to reduce the semantic overlap between them.
